(19) United States
(12) Patent Application Publication
(10) Pub. No.: US 2011/0126092 A1
(43) Pub. Date: May 26, 2011

(54) Smart Paste

(75) Inventor: Scott C. Harris, Rancho Santa Fe, CA (US)

(73) Assignee: HARRIS TECHNOLOGY, LLC, Rancho Santa Fe, CA (US)

(21) Appl. No.: 12/623,385

(22) Filed: Nov. 21, 2009

(51) Int. Cl. G06F 17/24

(52) U.S. Cl. 715/256

(57) ABSTRACT

Information in a document is automatically parsed to determine its context. That context forms a score for the document, and that's score is later used to determine if or to determine something about other documents. Portions can be automatically pasted based on that information.

### BACKGROUND

Many different editing programs allow use of a copy and paste feature. This allows a user, for example, to a portion of a document from one place, and puts it into another place in the same or different document. The portion stored is kept in a memory called the clipboard. Whatever is in the clipboard is automatically pasted into the document location that is selected.

### SUMMARY

Embodiments describe using intelligent monitoring techniques for copying and/or characterizing copied portions and/or to automatically determine which of a plurality of different previously copied portions should be “pasted” into an insert portion.

One embodiment describes cut and/or paste in a word processing program, which can include a word processor, spreadsheet, presentation program, or the like. This program may be running on a personal computer that is programmed with an operating system.

### BRIEF DESCRIPTION OF THE DRAWINGS

FIG. 1 shows a computer system;

FIG. 2 shows a flowchart of copy and paste and metadata formation;

FIG. 3 shows rule formation in a form;

FIG. 4 shows copying a whole form and mining data from that form;

FIG. 5 shows a correction operation;

FIG. 6 shows the cut and paste;

FIG. 7 shows a flowchart of another embodiment;

FIG. 8 shows a flowchart of picture selection.

### DETAILED DESCRIPTION

Throughout this description, a description is provided of copying at least one portion of a document and pasting it into a paste location. However, it should be understood that copying is also intended to encompass cutting, where cutting is the action of taking an item from the document and leaving nothing in its place within the document. It should also be understood that while pasting refers to the operation of putting the cursor in a specified place, and taking an action to insert the portion at that place, it should be understood that pasting can also include any other way of placing information into a document. This may include any of the pasting techniques described herein. Moreover the term “document” can include any items that can be viewed on a computer, including editable documents, read only documents, web pages, videos and images, sound files, and others.

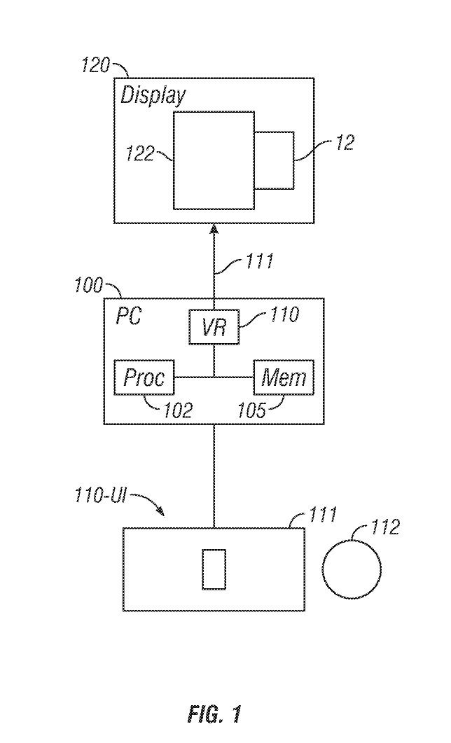

FIG. 1 shows a personal computer 100 having a processor 102 and memory 105. The memory may be any kind of memory including solid-state memory, hard drive, RAM, or a combination thereof. The personal computer also includes a video rendering part 110 which produces an output video signal 111 that is displayed on an external display 120. The display 120 may show, for example, word processing documents 122, spreadsheet documents 123, and any others. The personal computer 100 receives input from a user interface 110 which can include a keyboard 111, mouse 112, or any other desired kind of user interface devices.

The processor 102 runs programs which have been “installed” in the memory 105. One of those programs may include: either as an integral part thereof, or as an add-in thereto, a program which does smart pasting of the type disclosed herein.

Throughout this disclosure, the functions are carried out by software that is executed by the processor 102, either alone or in conjunction with all or parts of the memory, and possibly other components of the computer. For shorthand, it will be explained that this processor or these functions are simply carried out; however it should be understood that these functions are only carried out by the processor doing these operations.

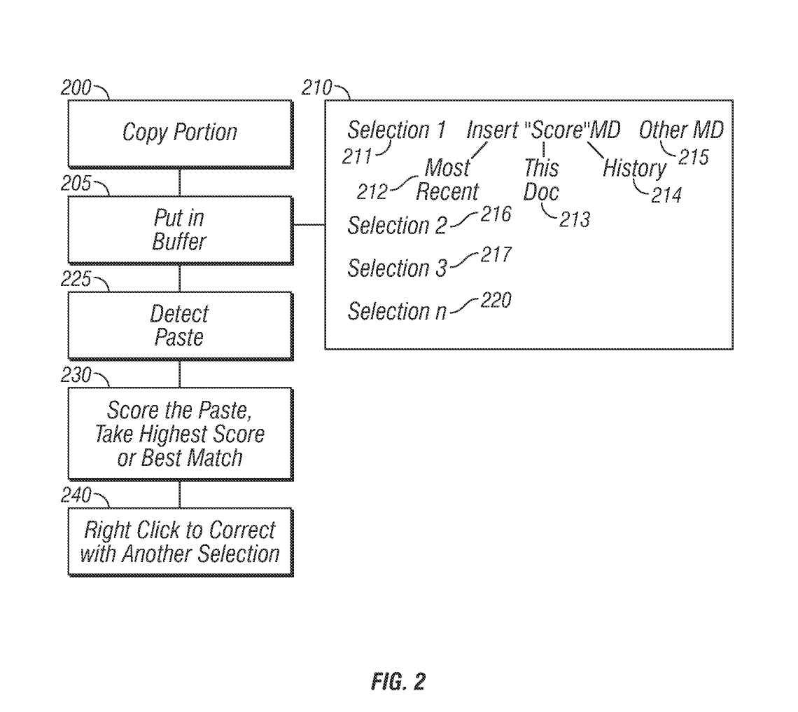

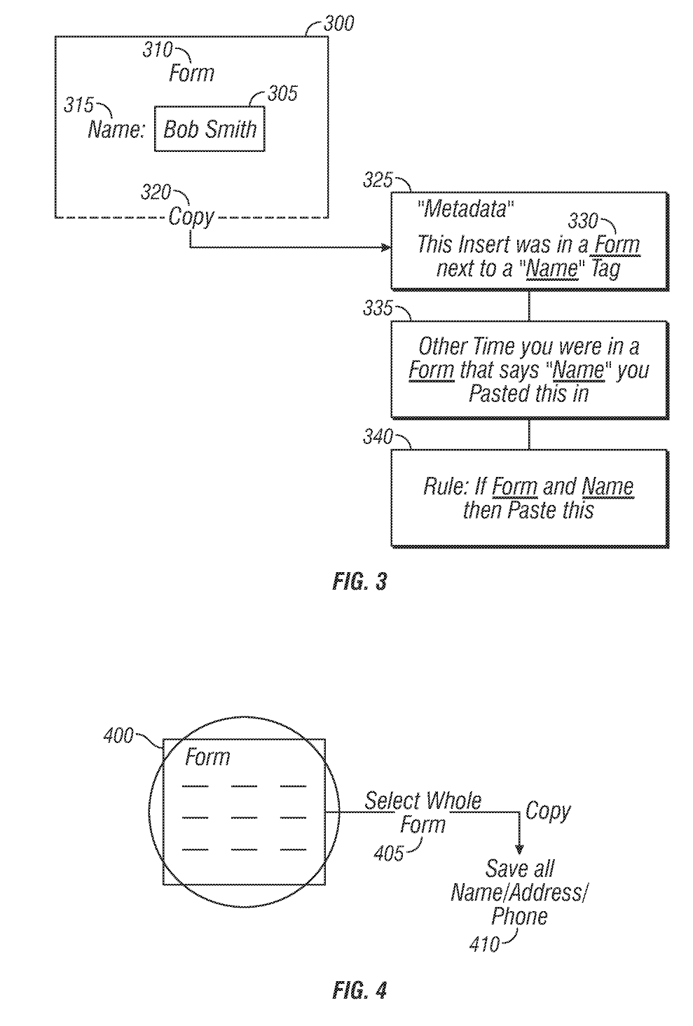

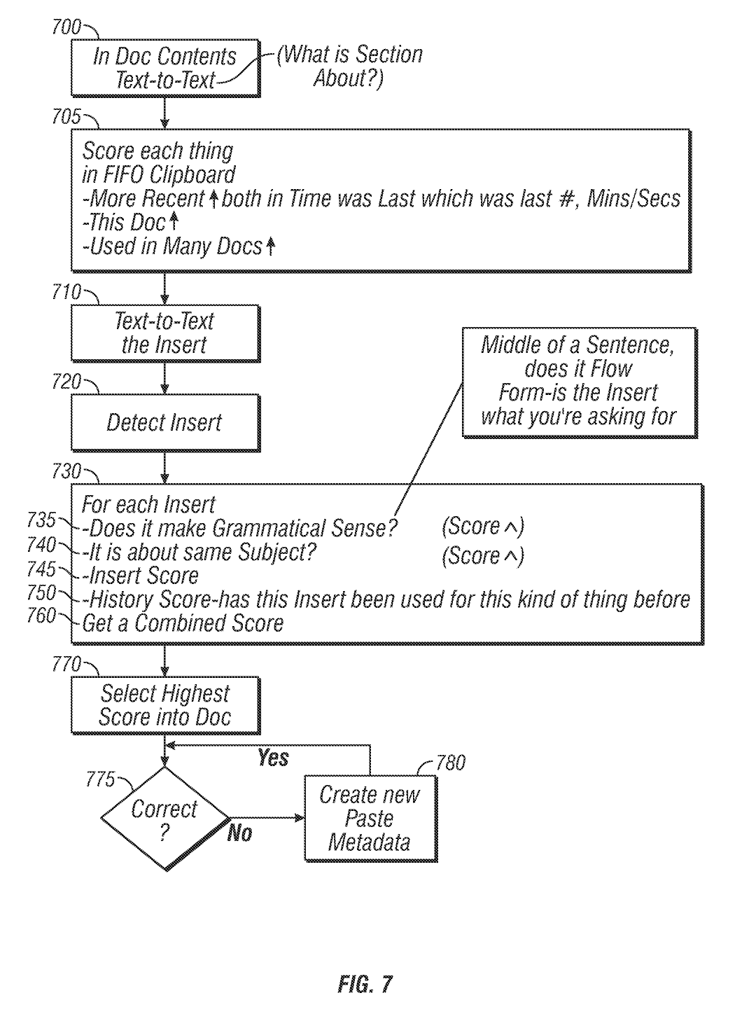

The overall flowchart of the smart paste program is shown in FIG. 2. At 200, the system operates to copy a portion. That portion may be from any document or any source. At 205, portion thus copied is placed into a buffer, which in an embodiment can be a buffer. Each selection placed into that buffer is placed along with a number of pieces of identifying information. 210 shows an exemplary table for the information. Selection one, shown as number 211 is shown with its “insert score” 221. The insert score includes information about the copying, including, for example, one or more of is this the most recently copied information, shown as 212. The document source 213 is also shown, indicating whether the copied information from the current document or from another document, and if from another document, is the window with that document still open. History of other pastes is also shown as 214. Other scoring criteria are shown as 215 and are described throughout this specification, and can include document context scoring of FIGS. 3-5, time-since-copy of FIG. 6, and/or the auto-creation of FIG. 7. While the above discusses “scoring” using the metadata, other forms of identifying and identifying information can be used.

There are many selections in the buffer, including selection 2 (216), selection 3 (217), up to selection n, the oldest selection shown as 220.

At 225, the program operation detects a paste indication.

The paste indication can be carried out from menus, or using a shortcut key. For example, Windows programs conventionally use the shortcut “control v” to indicate that a paste should be carried out at the current location.

At 230, the paste is scored, with the scoring carried out against different items in the buffer 210. The highest match score or overall best match at 235 is found. This highest match score is then inserted into the document at the location. 240 represents a correcting operation, which allows the user to right-click or take some other action to correct the pasted information by substituting a different selection.

The pasting is carried out according to a number of different parameters. As described throughout this specification.

One basic function of this system allows copying selections into the improved clipboard/buffer, and those copied items remain in the buffer with scores. The selections stay in the buffer. The clipboard can be partially or totally cleansed; for example, items that are less likely to be used can be removed by removing items with scores that are lower than a certain amount, or items that have not been used in a certain amount of time.

The smart paste according to the present embodiment enables automatically pasting one item into a destination. In order to do this, the program carries out a smart detection of the different contents in the memory and also of the surroundings of the pasting.

FIG. 3 illustrates a first embodiment, where a user selects the area 305 within a form 300. The area 305 in FIG. 3 is a person's name in the context of a form 310. Typically, this name is near an indication such as “name” 315 or “your name”. When the user copies this section using the copy operation 320, the device creates information about the copied text. The information represents characteristics of the copied text; however that information is different than the copied text itself. This “information” is referred to herein as metadata 325, however it should be understood that this is different than conventional metadata. The metadata 325 tells the system everything that it can about the copied information, including information described throughout this specification.

The metadata shown at 330 shows things that were automatically figured out by the computer—here that this is within a form and that it was next to a tag that indicated “name”.

This part of the metadata 325 may represent the metadata obtained from the copying. For example, the metadata can be a feature vector or multi-part variable that indicates all of the different possible situations, a document type (here, a form) and location in the form, including words around the form.

The second part 335 of the metadata represents characteristics of the pasting, as compared with the characteristics of the copying represented by the first metadata set 325. The pasting metadata set 335 contains information about actions that occurred other times in the similar environments. For example, this might have information, as shown in FIG. 3—indicating that the other time you were in a form that said “your name”, you pasted in this information. That is, every time the person carries out a paste action, close quote you pasted this in. This pasting in manually can represent a result of the smart paste. Therefore, these two different kinds of metadata can be compiled by the system into rules about when to use the smart pasting. The rule for example can be shown as 340, for example, if form, and name: then paste this. This is shown as a text version of the compiled form, but it should be understood that the rule itself may be put in some other form such as a feature vector. This “rule” can also be outside the usual scoring techniques described above, so that instead of a score such as a numerical scoring, this just forms a normal rule.

The above shows copying individual entries, but it should be understood that bulk copying can also be carried out. For example, the user can select and “copy” the whole form as shown in FIG. 4. The whole form 400 is selected at 405, and copied/pasted at 410. This creates entries for all of the different entered information including for example name, address, and phone number, where each entry can be assigned with metadata based on an automatic analysis.

Although the above describes two kinds of metadata, both copy metadata and paste metadata, it should be understood that either kind alone can be used according to embodiments, and that other kinds of metadata can also be used.

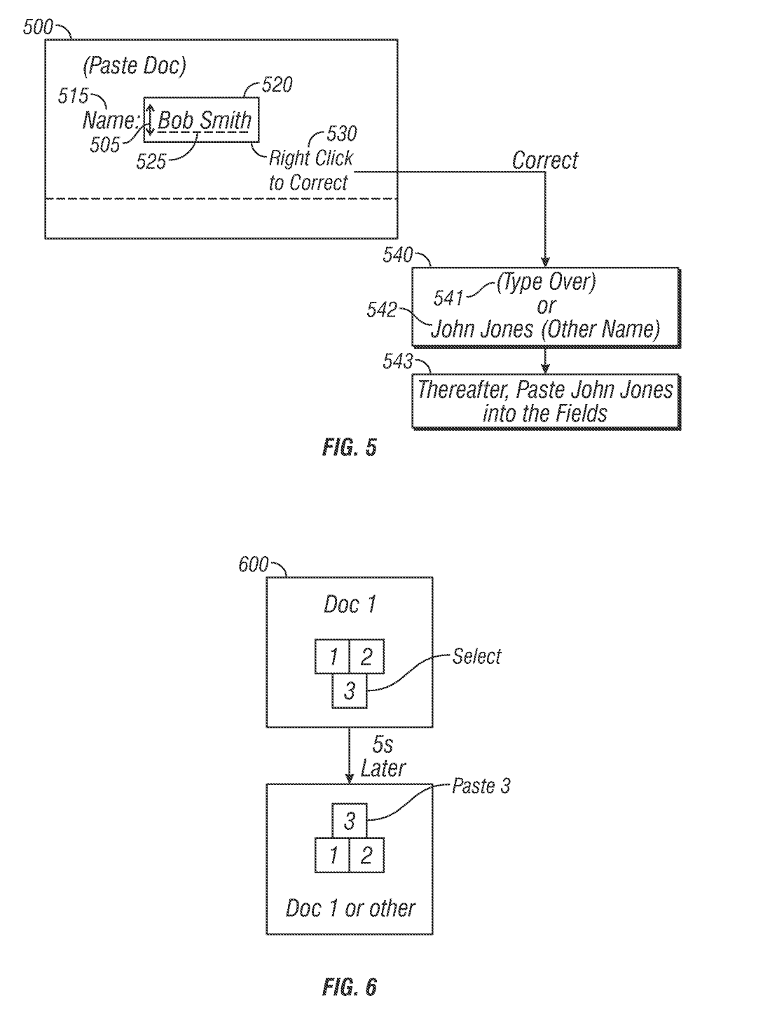

The pasting operation itself is shown in FIG. 5.

In FIG. 5, a user in a form such as 500 puts the cursor in a location such as 505. The system automatically than parses the surroundings to the copied area 505, shown generally as the area 510. In parsing this material, the system sees the word “name” 515, which may match to the metadata 330 that has been previously stored. Pasting, therefore, matches to the metadata 325, and hence causes the word “Bob Smith” to be pasted at 520.

The value is pasted with an indication shown here as 525, indicating that this has been automatically selected from the buffer.

A user can select the automatically inserted items to change the insertion techniques. Once selected, the user is given a number of different options shown generally as 540. Those options may include simply typing over the name 541. The options may include other names in the list 542. In the embodiment, when the user selects some other name like this, the selection itself becomes part of the metadata at 543, here upping the score for the possibility that the user should thereafter paste “John Jones” into those fields.

Another form of information which can be placed as part of the metadata is temporal information. FIG. 6 illustrates a cut and paste operation. In a document 600, the user first selects element one. 1-15 seconds later, the user pastes in either the same or a different document. Some copy and paste operations are carried out in this way, where a copy is made, and paste quickly follows thereafter. When copy is made 5 seconds later, this is a good indication that the paste should be exactly what was copied. When the paste is 30 minutes later, however, this becomes less likely. As the paste time becomes longer since the copy, it becomes less likely that this is a straight “move” operation.

Therefore a form of the metadata will also include the time of copying, and also the time since the last thing you selected. The score of the last thing you selected may be one of the highest scored items in the scoring system, and has a higher score when more recently selected.

This may be based on one or more system rules. One system rule might be that you obtain a very high score for in the last item that was copied, when it is pasted within three minutes. However, a very high score for recent copying may be overridden by a high score obtained from a metadata system which sees an exact match, for example, in the above example, the word “name” in a form.

Another scoring operation may use text to text operation. This is illustrated, for example, in FIG. 7, which is a flowchart that is executed by the computer. At 700, for each entry, the system may parse the document contents; at least in areas before and after be copied selection. The parsing tries to find—what has this section been about? This may also form a piece of the metadata scoring unit. 705 indicates the other scoring sections, where more recent get a higher score, more recent in time get a higher score, same document gets a higher score, and used many times in many documents will also give a higher score. Other items may also give a higher score.

At 710, the insert itself is text to text evaluated along with its content in the document. More generally, the insert itself may be evaluated for its content.

At 720, that is a detection of the user having requested an insert into a document in a specified way. At 730, for each insert, the insert context is scored. The insert context carries out a number of different tests. At 735, this tests to see if the insert makes grammatical sense in context. If the insert is in the middle of a sentence, for example, does the sentence flow? In a form, is the insert specifically what you're looking for? If so, the score is increased.

Test 740 determines whether the information is about the same subject as the insert around it. This can use both text to text techniques, as well as metadata, to determine the information. Inserts which are about the same subject as their surroundings receive an increased score. 745 represents the insert score: how long since this was copied, was it the last copy, was the copy in this document or was it in a concurrently open document, and other “insert” scoring techniques as described herein.

750 provides a history score, which is from the paste metadata. Specifically, that history score represents whether this insert has been used previously in this way at 750.

At 760, all of this is put together to obtain a combined score. The insert which has the highest score is then pasted into the document at 770.

The thus-pasted insert can be corrected at 775, where the correction creates new paste metadata at 780. The non-correction may also create new paste metadata, since it means that the selection has been correctly done.

The above has described copying text, however in other embodiments, other computer-readable files it should be understood that any item can be copied. For example, this system can be used for copying pictures, copying HTML documents, webpages, e-mail, or the like. This creates the ability to carry out a new form of document creation and information mining.

While the user is within (e.g., reading) a webpage, or document or anything that is shown on their computer, for example, the user can select any item. For example, while in a webpage, the user can select either a section of information, or a picture, with the idea of using that later. The time when they use it can be much later—days or weeks, for example. This can also be done to collect information for a report that they are writing.

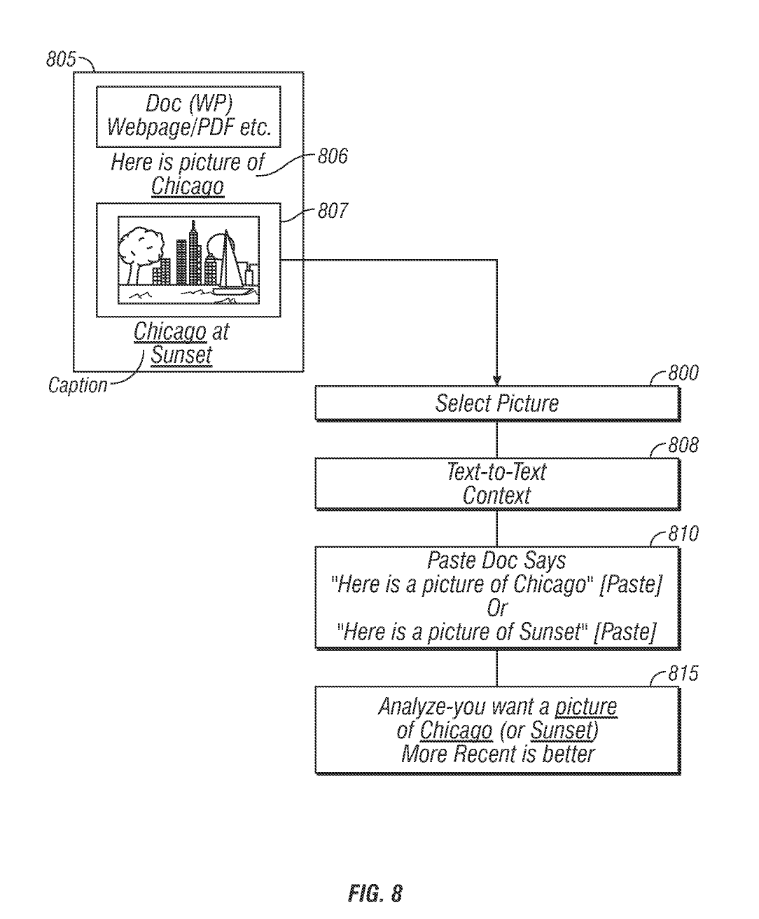

FIG. 8 shows a flowchart, where at 800, the user selects (and copies) a picture of the city of Chicago. The copying computer at 805 analyzes the webpage. Within the webpage, a caption, or other part within the file, may have words indicating, for example, that this here is a picture of Chicago, shown as 806. Another analysis finds the words “Chicago at sunset” in the picture caption. The user copies this at 807. The system can text to text or otherwise analyze the area around the copy portion at 809, to determine the metadata or other information about the selected portion. Each of the italicized elements may be keywords found or used by the system.

At 810, the user is later carrying out some action, e.g., typing an e-mail or typing a report. As part of that e-mail, the user types “here is a picture of Chicago”, then selects paste. From this, the system can determine that you want to paste a picture of Chicago. While more recent will receive a higher score, the paste can automatically find a picture of Chicago in this way, and paste it at 815.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, the programs used herein can be any kind of program, editor, browser, or other. The copy and paste can be any function that receives information into memory, for example, can be all-automatic.

While the above has described the copying computer doing analysis to determine the metadata, other computers can do this analysis. For example, a web page or other document can include embedded metadata about the sections that might be copied to facilitate the smart copy and/or paste operation described herein.

Also, the term metadata is used by the inventor to indicate any data that represents the contents of these files using any or all of the techniques described in this application. It can include, but is not limited to, the kinds of metadata associated with html or video files.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method, comprising:
in a computer that has memory that can be used to store electronic information, receiving an action that requests copying of insert information from a currently-viewed document into a location of said memory;
storing said insert information in said memory in a location, from which location the information can later be pasted into a document;
automatically forming identifying information about said insert information, said identifying information indicating characteristics of the insert information;
obtaining other copied insert information, and also storing said other copied insert information and automatically forming identifying information about said other information; and
using said identifying information to determine which of said insert or said other copied insert information should be pasted into a document.

2. A method as in claim 1, further comprising pasting into a document, said pasting automatically selecting one of said insert or said other copied insert information, and pasting said one into said document.

3. A method as in claim 2, wherein said automatically selecting comprises using said identifying information, along with a location of pasting to determine a most likely copied insert among a plurality of copied inserts, to be pasted in said location.

4. A method as in claim 3, wherein said identifying information comprises first information about a first context in the document from which the copying occurred, said first context including at least one of the words before the copying and/or the words after the copying.

5. A method as in claim 4, wherein said identifying information comprises second information about a second context in the document from which the pasting is to occur, said second context including at least one of the words before the pasting and/or the words after the pasting.

6. A method as in claim 3, wherein said identifying information comprises information about a context in the document from which the pasting is to occur, said context including at least one of the words before the pasting and/or the words after the pasting.

7. A method as in claim 3, wherein said identifying information comprises information about a context of at least one of a copying document or a pasting document, said context obtained by automatic analysis by the computer of a subject of said context by analyzing at least an area of the document.

8. A method as in claim 1, further comprising using the computer for automatically summarizing information in the document to obtain said identifying information.

9. A method as in claim 1, wherein said copied insert information is text.

10. A method as in claim 1, wherein said copied insert information is a picture, and said identifying information is information about the content of the picture.

11. A computer system, comprising:
a processor;
a user interface port, which receives commands entered by a user;
at least one memory that stores electronic information including a program that operates under control of said processor and with communication via said user interface port,
said program when running on said processor receiving an action that requests copying of insert information from a currently-viewed document into a location of said memory, and automatically forming identifying information about said insert information, where said identifying information indicating characteristics of the insert information, said program also obtaining other copied insert information, and also storing said other copied insert information and automatically forming identifying information about said other copied insert information, and said program using said identifying information to determine which of said insert or said other copied insert information should be pasted into a document.

12. A system as in claim 11, wherein said program further comprises pasting into a document, said pasting automatically selecting one of said insert or said other copied insert information, and pasting said one into said document.

13. A system as in claim 12, wherein said program uses said identifying information, along with a location of pasting to determine a most likely copied insert among a plurality of copied inserts, to be pasted in said location.

14. A system as in claim 13, wherein said program forms said identifying information to include first information about a first context in the document from which the copying occurred, said first context including at least one of the words before the copying and/or the words after the copying.

15. A system as in claim 14, wherein said program forms said identifying information to also include second information about a second context in the document from which the pasting is to occur, said second context including at least one of the words before the pasting and/or the words after the pasting.

16. A system as in claim 11, wherein said wherein said program forms said identifying information using automated text-to-text operations.

17. A system as in claim 11, wherein said copied insert information is a picture, and said identifying information is information about the content of the picture.

18. A computer program product, comprising a computer usable medium having a computer readable program code embodied therein, said computer readable program code adapted to be executed by a processor which is in communication with a user interface port, which receives commands entered by a user, the set of instructions comprising:
storing said insert information in a memory location, from which location the information can later be pasted into a document;
automatically forming identifying information about said insert information, said identifying information indicating characteristics of the insert information;
obtaining other copied insert information, and also storing said other copied insert information and automatically forming identifying information about said other information; and
using said identifying information to determine which of said insert or said other copied insert information should be pasted into a document.

19. A product as in claim 18, further comprising instructions which carry out pasting into a document, said pasting automatically selecting one of said insert or said other copied insert information, and pasting said one into said document.

20. A product as in claim 19, wherein said automatically selecting comprises instructions which carry out using said identifying information, along with a location of pasting to determine a most likely copied insert among a plurality of copied inserts, to be pasted in said location.

21. A product as in claim 20, wherein said identifying information comprises first information about a first context in the document from which the copying occurred, said first context including at least one of the words before the copying and/or the words after the copying.

22. A product as in claim 21, wherein said identifying information also comprises second information about a second context in the document from which the pasting is to occur, said second context including at least one of the words before the pasting and/or the words after the pasting.

23. A product as in claim 20, wherein said identifying information comprises information about a context in the document from which the pasting is to occur, said context including at least one of the words before the pasting and/or the words after the pasting.

24. A product as in claim 20, further comprising instructions which carry out text to text operations to automatically determine a context of at least one of a copying document or a pasting document, said context obtained by automatic analysis by the computer of a subject of said context by analyzing at least an area of the document to form said identifying information.

25. A product as in claim 18, wherein said copied insert information is text.

26. A product as in claim 18, wherein said copied insert information is a picture, and said identifying information is information about the content of the picture.
